(19) United States
(12) Patent Application Publication
(10) Pub. No.: US 2026/0092129 A1
(43) Pub. Date: Apr. 2, 2026

(54) Controlled Molecular Weight Distribution of Isobutylene-Based Elastomer Compositions and Methods Related Thereto

(71) Applicant: ExxonMobil Chemical Patents Inc., Spring, TX (US)

(72) Inventors: Sunny Jacob, Seabrook, TX (US); Ramkiran Mattupalli, Singapore (SG); Lili Li, Shandong (CN); Stephen A. Lassard, Denham Springs, LA (US)

(21) Appl. No.: 19/110,224

(22) PCT Filed: Sep. 1, 2023
(86) PCT No.: PCT/US2023/073294

§ 371 Date: Mar. 10, 2025

Related U.S. Application Data
(60) Provisional application No. 63/405,925, filed on Sep. 13, 2022.

(51) Int. Cl. C08F 2/40; C08C 19/12; C08F 2/00; C08F 2/01; C08F 4/14; C08F 210/12

(52) U.S. Cl. CPC C08F 2/40; C08C 19/12; C08F 2/001; C08F 2/01; C08F 4/14; C08F 210/12; C08F 2400/02

(57) ABSTRACT

Methods for controlling molecular weight distribution of elastomer compositions and, in particular isobutylene-based elastomer compositions, particularly for use in tire compositions such as innerliners. A polymerization medium comprising monomers, diluent, and a catalyst system are polymerized in a reactor. Molecular weight distribution is controlled using post-polymerization processing to achieve a Mooney Relaxation Index of greater than about 2.5.

### CROSS-REFERENCE TO RELATED APPLICATION

This application claims priority to and the benefit of U.S. Provisional Patent Application 63/405,925, filed 13 Sep. 2022, entitled CONTROLLED MOLECULAR WEIGHT DISTRIBUTION OF ISOBUTYLENE-BASED ELASTOMER COMPOSITIONS AND METHODS RELATED THERETO, the disclosure of which is incorporated herein by reference in its entirety.

### FIELD OF INVENTION

This application relates to methods for controlling molecular weight distribution of elastomer compositions and, in particular, isobutylene-based elastomer compositions, particularly for use in tire compositions such as innerliners.

### BACKGROUND

Tires contain many rubber compounds and other materials required to safely perform in a wide range of demanding conditions for passenger, truck, bus, and aircraft vehicles, for example. They are expected to perform over many thousands of miles while retaining their essential performance and safety properties. Tire performance is at least partially dependent upon their ability to retain air or inflation pressure. Butyl rubbers, such as isobutylene-based elastomers, are particularly suitable for air retention and can be formulated for specific tire applications, such as tire tubes or innerliners, the innermost layer of a tire. A particular butyl rubber composition, including additional additives, for use an innerliner is selected in order to achieve suitable characteristics related to, among other things, processability and uncured v. cured physical properties, which include mechanical strength, surface appearance, and splice integrity. A number of factors can influence these properties.

Molecular weight distribution (MWD=Mw/Mn), also called polydispersity index, has a significant effect on the mechanical and physical bulk properties of polymers and resultant compounded products, including those that are integral for manufacturing commercially viable tire innerliners—processability and uncured v. cured physical properties. For innerliner applications, the butyl rubber compound Mooney viscosity and Mooney relaxation are important for producing rubbers with innerliner splicing characteristics that result in suitable splice strength integrity after curing. A balance of the MWD of butyl rubber (high v. low molecular weight butyl rubber) is needed to achieve these properties while maintaining processability; high molecular weight fractions contribute to mechanical properties, such as tensile break, elongation, impact strength, and the like, whereas low molecular weight fractions contribute to processability factors, such as low melt viscosity, plasticizer quality, and the like. Accordingly, a broad MWD of butyl rubber is of significance for the production of commercially viable tire innerliners and, ultimately, final tire products.

Butyl rubber polymerization is conventionally carried out using an appropriate monomer and Lewis acid catalyst (and initiator). However, widespread inconsistency in MWD of butyl rubbers throughout the tire industry have been previously documented. It has further been observed that innerliner tire products currently produced typically show narrow MWDs, such as MWDs less than about 2.5. As described above, narrow MWD can lead to processing difficulties and/or undesirable physical and mechanical properties.

The present disclosure provides methods and systems for producing isobutylene-based elastomer compositions having controlled MWDs, particularly for use as tire innerliners.

### SUMMARY

In nonlimiting aspects of the present disclosure, a method of polymerizing a polymerization medium in a reactor, the polymerization medium comprising a monomer, a diluent, and a catalyst system, and the catalyst system comprising a Lewis acid and an initiator, thereby resulting in a reactor overflow; contacting the reactor overflow with a quenching agent; and controlling a quenching of the reactor overflow to obtain a Mooney Relaxation Index (MRI) of greater than about 2.5, thereby resulting in quenched reactor overflow.

These and other features and attributes of the disclosed controlled MWD methods and systems for producing isobutylene-based elastomer composition of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a schematic flow diagram of a simplified polymerization system 100, according to one or more aspects of the present disclosure.

FIG. 2 is a chart displaying MRI values for experimental Phase conditions, according to one or more aspects of the present disclosure.

FIG. 3 is a gel permeation chromatography chart showing the MWD values for experimental Phase conditions, according to one or more aspects of the present disclosure.

FIG. 4 is a chart displaying isobutylene conversion values for experimental Phase conditions, according to one or more embodiments of the present disclosure.

FIG. 5 is a chart displaying isobutylene conversion values for experimental Phase conditions, according to one or more embodiments of the present disclosure.

### DETAILED DESCRIPTION

This application relates to methods for controlling molecular weight distribution of elastomer compositions and, in particular, isobutylene-based elastomer compositions, particularly for use in tire compositions such as innerliners.

The present disclosure provides a methodology for controlling the MWD of isobutylene-based elastomer compositions by modifying certain polymerization characteristics. In particular, the present disclosure provides controlled MWD broadening during butyl polymer production by modifying the post polymerization reactor conditions to vary the concentration of low molecular weight fractions, the modification achieved by controlling the reaction quench to promote post reactor polymerization. According to the present disclosure, the quench may be controlled by one or more of varying the amount of quench agent; controlling the mixing efficiency, by one or more of the speed of the reactor blender and/or the viscosity of the reactor overflow; and/or increasing the temperature at the reactor outlet. The methodology presented herein allows for an isobutylene-based elastomer composition having controlled MWD, including controlled broadening of MWD for use in the production of tire innerliners.

In various aspects of the present disclosure, the Mooney Relaxation Index (MRI) is used as a proxy for evaluating the MWD of an isobutylene-based elastomer composition. Mooney viscometer readings (MRI) are commonly used to measure downstream polymerization product and are correlative to MWD, as described hereinbelow. The methodology of the present disclosure provides for isobutylene-based elastomer compositions having an MRI of greater than about 2.5. Indeed, standard isobutylene-based elastomer compositions have MRI values of less than about 2.5.

### Definitions

As used herein, the term “catalyst system,” and grammatical variants thereof, refers to and includes any Lewis acid(s) or other metal complex(es) used to catalyze the polymerization of hydrocarbon monomers and an optional at least one initiator. Other additives may be included, such as catalyst modifiers, for example. The catalyst system is combined with a diluent for polymerization, collectively termed a “polymerization medium.” A “polymerization system,” as used herein, and grammatical variants thereof, refers to the use of a polymerization medium to produce polymers.

As used herein, the term “diluent,” and grammatical variants thereof, refers to a dilution or dissolving agent, including mixtures thereof (e.g., two or more individual diluents). The diluent may further be used to impact reactor mixing (using an overhead blender) as it serves as a dilution agent.

As used herein, the term “solvent,” and grammatical variants thereof, refers to a chemical agent that can dissolve resultant polymers.

A “reactor,” and grammatical variants thereof, as used herein, refers to any container(s) in which a chemical reaction occurs, such as polymerization. Examples of a butyl polymerization reactor include a continuous flow-stirred tank reactor which utilizes continuous tank agitation, as well as a draft tube type reactor. Various cooling jackets, tubing, and the like, may be used in combination (and may be integral) with the reactor to control or otherwise maintain the reactor temperature during polymerization. Commercial reactors typically can be well mixed vessels of greater than 1,000 to 10,000 liters in volume (excluding jacket) with a high circulation rate provided by an axial pump. The polymerization and a pump can both generate heat and, in order to keep the slurry cold, the reaction system can include heat exchangers. In some reactors, slurry can circulate through tubes of a heat exchanger. Cooling can be provided, for example, by boiling ethylene on a shell side. Slurry temperature can be set by the boiling ethylene temperature, the required heat flux and the overall resistance to heat transfer.

As used herein, the term “slurry,” and grammatical variants thereof, refers to an amount of diluent comprising polymer that has precipitated from a catalyst system and diluent. The slurry concentration is the weight percent of the partially or completely precipitated polymers based on the total slurry.

As used herein, the term “quench,” and grammatical variants thereof, refers to a process of rapidly heating and mixing a reactor effluent stream with a quench medium, wherein further polymerization is terminated.

The term “polymer,” and grammatical variants thereof, as used herein refers to homopolymers, copolymers, interpolymers, terpolymers, etc. The term “copolymer,” and grammatical variants thereof, is meant to include polymers having two or more monomers. The term “interpolymer,” and grammatical variants thereof, means any polymer or oligomer having a number average molecular weight of 500 or more prepared by the polymerization or oligomerization of at least two different monomers. As used herein, when a polymer is referred to as “comprising” a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, the term “olefin,” and grammatical variants thereof, refers to a hydrocarbon containing a carbon-carbon double bond. An “isoolefin,” and grammatical variants thereof, refers to any olefin monomer having two substitutions on the same carbon. The term “diolefin,” and grammatical variants thereof, refers to any olefin monomer having two double bonds.

“Elastomer” or “elastomeric composition,” as used herein, and grammatical variants thereof, refers to any polymer or composition of polymers consistent with the ASTM D1566-21A (November 2021) definition. Elastomer may be used herein interchangeably with the term “rubber(s).”

“Mooney viscosity,” as used herein, and grammatical variants thereof, is the Mooney viscosity of a polymer or polymer composition. The polymer composition analyzed for determining Mooney viscosity should be substantially devoid of diluent and solvent. For instance, the sample may be placed on a boiling-water steam table in a hood to evaporate a large fraction of the diluent and unreacted monomers, and then, dried in a vacuum oven overnight (12 hours, 90° C.) prior to testing, in accordance with laboratory analysis techniques, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-19A (November 2019, but with the following modifications/clarifications of that procedure. First, sample polymer is pressed between two hot plates of a compression press prior to testing. The plate temperature is 125° C.+/−10° C. instead of the 50+/−5° C. as recommended in ASTM D1646-17, because 50° C. is unable to cause sufficient massing. Further, although ASTM D1646-17 allows for several options for die protection, should any two options provide conflicting results, PET 36 micron is used as the die protection. Further, ASTM D1646-17 does not indicate a sample weight in Section 8; thus, to the extent results may vary based upon sample weight, Mooney viscosity determined using a sample weight of 21.5+/−2.7 grams (g) per D1646-17 Section 8 procedures will govern. Finally, the rest procedures before testing set forth in D1646-17 Section 8 are 23+/−3° C. for 30 min in air; Mooney values as reported herein were determined after resting at 24+/−3° C. for 30 min in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4 @125° C. or ML, 1+8 @125° C.), where MU is the Mooney viscosity number, L denotes large rotor (defined as ML in ASTM D1646-17), 1 is the pre-heat time in minutes, 4 or 8 is the sample run time in minutes after the motor starts, and 125° C. is the test temperature. Thus, a Mooney viscosity of 90 determined by the aforementioned method would be reported as a Mooney viscosity of 90 MU (ML, 1+8 @125° C.) or 90 MU (ML, 1+4 @125° C.). Alternatively, the Mooney viscosity may be reported as 90 MU; in such instance, it should be assumed that the just-described (ML, 1+4 @125° C.) method is used to determine such viscosity, unless otherwise noted. In some instances, a lower test temperature may be used (e.g., 100° C.), in which case Mooney is reported as Mooney Viscosity (ML, 1+8 @100° C.), or @T° C. where T is the test temperature.

As used herein, the term “Mooney Relaxation Index” or “MRI,” and grammatical variants thereof, refers to a value correlative to MWD for isobutylene-based elastomers. It is determined based on Mooney Relaxation and may be determined according to Equation 1 below:

$$MRI = [ ( k / ( a + 1 ) ] [ 6 {0}^{( a + 1 )} - {4}^{( a + 1 )} ] ,$$

where a is regression slope and k is regression intercept in terms of Mooney Relaxation in units of 1 sec.

Numerical ranges used herein include the numbers recited in the range. For example, the numerical range “from 1 wt % to 10 wt %” includes 1 wt % and 10 wt % within the recited range.

### Polymerization System

The present disclosure provides methods for controlling MWD (and MRI) using post-polymerization controls and modifications of a polymerization system. In one or more aspects described herein, the present disclosure provides methodologies for varying low molecular weight fractions of isobutylene-based elastomer, thereby controlling the ratio of said low molecular weight fractions compared to the high molecular weight fractions of isobutylene-based elastomer as part of a polymerization system.

Before describing the methodology of the present disclosure in further detail, a brief overview of an example polymerization system for producing isobutylene-based elastomers is provided such that the various aspects of the present disclosure may be better understood.

Polymerization systems for producing isobutylene-based elastomers is typically carried out using a continuous slurry polymerization system, with a polymerization reactor temperature of less than 0° C., such as in the range of about −105° C. to about 0° C. It is to be appreciated, however, that a batch polymerization system may be used in accordance with one or more aspects described herein, without departing from the scope of the present disclosure.

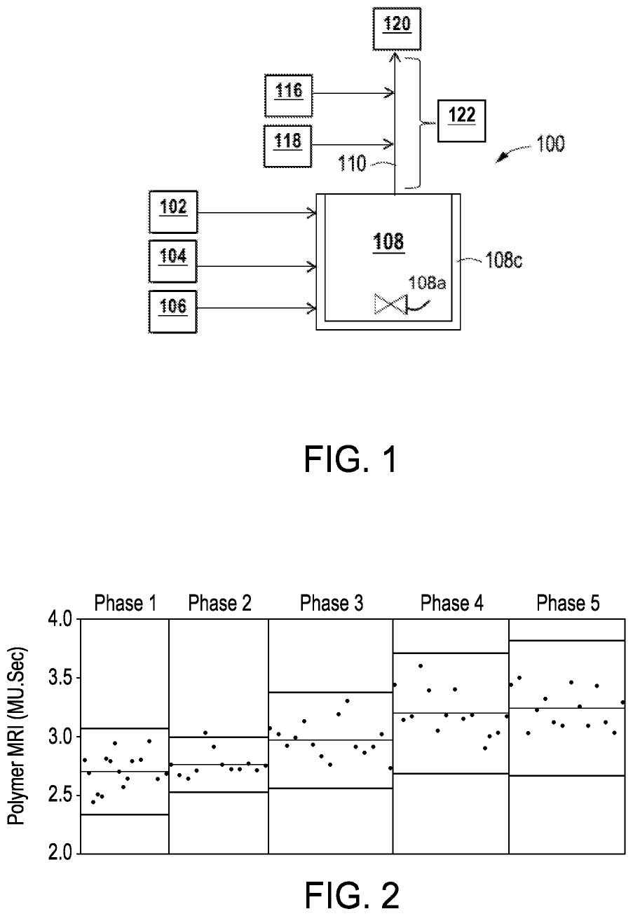

Referring now to FIG. 1, illustrated is a schematic flow diagram of a polymerization system 100, according to one or more aspects of the present disclosure. Catalyst system 102 and monomers 104 are fed into polymerization reactor 108. In some instances, the catalyst system 102 and monomers 104 may be blended in a blend unit (not shown) prior to being fed to the polymerization reactor 108. Further, in some instances, prior to introducing the monomers 104 into the polymerization reactor 108 (or blend unit), they may be treated to remove impurities, if necessary.

The catalyst system 102 and monomers 104 may be fed into the polymerization reactor 108 simultaneously or separately. The monomers 104, alone or in combination with the catalyst system 102, are fed into the polymerization reactor 108 at a temperature less than 0° C., such as in the range of about −105° C. to about 0° C. The catalyst system 102 and monomers 104 are mixed within the polymerization reactor 108 and may exist initially as a single phase dissolved in a diluent 106. The diluent 106 serves to dissolve the catalyst system 102 and monomers 104, without dissolving polymerization product (polymers) and, thus, allowing them to precipitate and form a slurry. When one or more of the inputs are simultaneously fed into the polymerization reactor 108, a single pump impeller may be used. The reactor pump impellers are typically capable of one or both of up-pumping or down-pumping and often include an electric motor with measurable amperage. The pump impeller serves to keep a constant flow of monomers, catalyst system, and diluent, including reacted and non-reacted species (e.g., monomers) within the reactor, and provide high shear mixing to prevent reactor fouling.

The polymerization reactor 108 may be any suitable reactor for polymerization to produce isobutylene-based elastomers. In one or more aspects, the polymerization reactor 108 is a continuous draft tube reactor or draft tube with a circulating pump 108a for efficient agitation. Typically, the polymerization reactor 108 is equipped with an external cooling jacket 108c and associated internal cooling (or heat-exchange) tubes to remove heat produced during polymerization and maintain desired reaction temperatures. In one or more aspects, the cooling tubes may include liquid ethylene to draw heat away from the polymerization reaction. The polymerization system further comprises a steam jacket 122 for aiding in control of molecular weight distribution, as described herein. The steam jacket 122 may be piping that receives the reactor effluent stream and provides heat thereto; that is the reactor effluent stream flows through steam jacket 122.

In one or more aspects, the polymerization reactor may have a volume, including the jacket and associated internal cooling tubes, in the range of about 1,000 liters (L) to about 10,000 L, encompassing any value and subset therebetween. Said volume is conducive for large scale volume polymerization reactions in accordance with the various aspects described herein. Accordingly, the reactors having larger volumes (and smaller volumes, though less preferred) may be utilized to facilitate up-scaling, without departing from the scope of the present disclosure.

Generally, the polymerization temperature within the polymerization reactor 108 for producing isobutylene-based elastomers of the present disclosure is in the range of about −105° C. to about 0° C., encompassing any value and subset therebetween, such as −100° C. to −50° C., or −98° C. to −92° C., and the like, preferably from 0° C. to the freezing point of the polymerization medium, such as the diluent and monomer mixture and then quenching the reaction by the addition of a quench agent in the polymerization medium.

During polymerization, the catalyst system 102 and monomers 104 react and the resultant polymers precipitate from the diluent 106. Reactor effluent stream 110 comprising polymers (produced during polymerization), diluent 106, unreacted monomers 104, and unreacted catalyst system 102 exits the reactor from a reactor outlet, which may be collectively referred to herein as “reactor overflow.” For isobutylene-based elastomer polymerization system 100, the reactor effluent stream 110 may be warmed to room temperature (RT) or otherwise heated, such as from the at or below 0° C. temperatures (within the polymerization reactor 108) to temperatures in the range of, for example, about −50° C. to about 20° C., encompassing any value and subset therebetween. The steam jacket 122 may be used to provide such heat.

Unreacted catalyst system 102 within the reactor effluent stream 110 may form undesirable species that interfere with downstream processing of the polymers produced during polymerization, such as functionalization thereof. During the warming or heating, but prior to heating above about −50° C. to about 20° C., the reactor effluent stream 110 may be quenched 118, with quenching agent. Quenching serves to terminate the reactive capability of all unreacted catalyst system 102 (that is, the catalyst(s) within the catalyst system 102) prior to any significant warming or heating of the reactor effluent stream 110 in order to prevent continued polymerization and crosslinking reactions from occurring as the reactor effluent stream 110 is heated, which may interfere with downstream processing. Traditional quenching agents include steam and/or hot water introduced to the reactor effluent stream 110. Other traditional quenching agents include alcohols, linear or branched, such as ethanol, tert-butanol, methanol, triethylene glycol (TEG), and any combination thereof. During quenching, reactor effluent stream 110 may be combined with solvent 116, and using a mechanical agitator located inside the overflow pipe of 110, in order to dissolve and fractionate desired polymers stream 118 for downstream processing 120 (e.g., halogenation or other functionalization, and the like) from diluent(s) 106, solvent(s) 116, and any unreacted monomers 104 or diluent or solvent to a tank or other storage container (not shown). The contents within the tank may be recycled in one or more aspects of the present disclosure.

### Polymerization System for Controlling the MWD (and MRI) of Isobutylene-Based Elastomers

The methodology of the present disclosure for producing isobutylene-based elastomers having controlled MWD (and MRI) generally utilizes existing polymerization systems, such as that described with reference to FIG. 1, but employs unconventional post-polymerization (post-reactor) processes. These post-polymerization processes advantageously can be used to broaden the MWD of a resultant isobutylene-based elastomer product by generating low molecular weight polymer while preventing polymeric degradation. While the present disclosure is described with reference to tire innerliners, having a desirable broad MWD of isobutylene-based elastomer, it is to be appreciated that the present disclosure may be applicable to other types of air retention products or may be applicable to other products that have a desirable broad MWD. That is, the various aspects of the present disclosure may be used to control MWD (and MRI) generally for isobutylene-based elastomers, without departing from the scope of the present disclosure.

In one or more aspects, the present disclosure provides a polymerization system for polymerizing a polymerization medium, the polymerization medium comprising one or more monomers, a diluent, and a catalyst system.

The one or more monomers for use in the present disclosure may include any hydrocarbon monomer. Suitable examples of hydrocarbon monomers include, but are not limited to, one or more of an olefin, an alpha-olefin, a di-substituted olefin, an isoolefin, a conjugated diene, a non-conjugated diene, a styrene, a substituted styrene, a vinyl ether, and any combination thereof. In one or more aspects of the present disclosure, an exemplary monomer combination includes isobutylene and para-methyl styrene. In one or more aspects of the present disclosure, an exemplary monomer combination includes isobutylene and isoprene, thus forming a poly iosobutylene-co-isoprene (or, when halogenated, a halogenated poly isobutylene-co-isoprene), for example. In each exemplary combinations, as well as any monomer combinations used in the polymerization systems of the present disclosure, homopolymers of isobutylene may additionally be included.

When two or more monomers (with or without homopolymers of isobutylene) are used in various aspects of the present disclosure, they may be present in equal or unequal amounts, without departing from the scope of the present disclosure. For instance, in various examples described hereinbelow, the monomers selected are isobutylene and isoprene, with isobutylene being the primary monomer present in concentration, thus forming a poly iosobutylene-co-isoprene (or, when halogenated, a halogenated poly isobutylene-co-isoprene), for example.

In one or more aspects, the monomers may be present in a polymerization medium in an amount ranging from about 30 wt % to about 40 wt %, such as about 30 wt % to about 35 wt %, or about 35 wt % to about 40 wt %, encompassing any value and subset therebetween.

The diluent is selected to dissolve the catalyst in the catalyst system and the monomer(s) and allow precipitation of polymerization product (polymers). An acceptable relatively low viscosity of the polymerization medium is obtained enabling the heat of polymerization to be removed more effectively by surface heat exchange. Suitable diluents include organic compounds, particularly those with an affinity for hydrocarbon fluids. Examples of suitable diluents for use in the present disclosure include, but are not limited to, hydrocarbons, such as hexanes, heptanes, halogenated hydrocarbons, such as chlorinated hydrocarbons, such as ethyl chloride, methyl chloride, CHCl₃, CCl₄, n-butyl chloride, chlorobenzene, and the like, and any combination thereof. Methyl chloride, for example, is a commercially acceptable diluent due to its suitable freezing and boiling points, and tends to produce relatively high molecular weight butyl rubber polymers.

According to one or more aspects of the present disclosure, a diluent, such as methyl chloride or hexane, is selected for use in the polymerization systems described herein for controlling MWD (and MRI) and advantageously can achieve an isobutylene-based elastomer polymerization product concentration in the range of about 25 vol % to about 40 vol %, such as about 26 vol % to about 37 vol %, encompassing any value and subset therebetween, such as about 30 vol % to about 35 vol %. In some instances, the isobutylene-based elastomer polymerization product concentration is about 30 vol %.

The amount of diluent may be adjusted according to one or more aspects of the present disclosure to adjust viscosity of the reactor overflow, as defined herein, to control MWD (and MRI).

The catalyst systems of the present disclosure include a Lewis acid(s) or metal complex(es) and an initiator. The Lewis acid(s) or metal complex(es) are intended to catalyze cationic polymerization to produce isobutylene-based elastomers. Aluminum-based Lewis acids may be used in various aspects of the present disclosure. Suitable examples of aluminum-based Lewis acids include, but are not limited to, aluminum trichloride, aluminum tribromide, ethyl aluminum dichloride (EADC), ethyl aluminum sesquichloride, diethyl aluminum chloride, methyl aluminum dichloride, methyl aluminum sesquichloride, dimethyl aluminum chloride, and the like, and any combination thereof alone or with other suitable Lewis acids. Other suitable examples include boron-based Lewis acids, such as boron trifluoride, and titanium-based Lewis acids, such as titanium tetrachloride, and the like, and any combinations thereof alone or with other suitable Lewis acids. In exemplary aspects of the present disclosure, the selected Lewis acid(s) include ethyl aluminum dichloride and ethyl aluminum sesquichloride, which may be in combination.

According to one or more aspects of the present disclosure, ethyl aluminum dichloride (EADC) is selected for use in the polymerization systems described herein for controlling MWD (and MRI). In one or more aspects, the EADC Lewis acid and initiator may be, based on molar basis at 3, present in the polymerization systems described herein in a range of about 2.5 to about 3, encompassing any value and subset therebetween. Such ratio is equally applicable to any Lewis acid(s) or metal complex(es) to initiators, as described herein, without departing from the scope of the present disclosure.

Various initiators may be used in the polymerization systems of the present disclosure for controlling the MWD (and MRI) of isobutylene-based elastomers, provided that they are compatible with the other components of the polymerization medium. The initiator for use in the present disclosure is selected such that it is capable of being complexed in a suitable diluent with the chosen Lewis acid(s) or other metal complex(es) to yield a complex which rapidly reacts with the hydrocarbon monomer(s) thereby forming a propagating polymer chain (polymerization). Suitable examples of initiators for use in the present disclosure include, but are not limited to, Brønsted acids such as H₂O, HCl, RCOOH (wherein R is an alkyl group), alkyl halides, such as (CH₃)₃CCl, C₆H₅C(CH₃)₂Cl, 2-chloro-2,4,4-trimethylpentane, and 2-chloro-2-methylpropane, a hydrogen halide, and any combination thereof. Other suitable initiators may also be used, as would be known by one of skill in the art.

According to one or more aspects of the present disclosure, hydrogen chloride (HCl) is selected as the initiator for use in the polymerization systems described herein for controlling MWD (and MRI). In one or more aspects, the HCl initiator is diluted in the diluent (e.g., hexane, methyl chloride) at a concentration of about 70 parts per million (ppm) to about 300 ppm, encompassing any value and subset therebetween, such as about 100 ppm to about 250 ppm, or about 150 ppm to about 200 ppm, or about 125 ppm, and the like. The diluted initiator may be present in a ratio to the monomer(s) (e.g., isobutylene) on a weight basis of about 30 ppm to about 60 ppm, encompassing any value and subset therebetween, such as about 40 ppm to about 50 ppm, such as about 40 ppm, and the like. Such concentrations in diluent and ratios to monomer(s) is equally applicable to any initiators, as described herein, without departing from the scope of the present disclosure.

### Methodology for Controlling the MWD (and MRI) of Isobutylene-Based Elastomers

In one or more aspects herein, a method is provided in which post-polymerization controls and modifications of a polymerization system are employed by controlling certain characteristics of the reaction quench to promote post-polymerization. These post-polymerization controls and modifications may include one or more (including all) of varying the amount of quenching agent and, in particular, TEG, and/or quenching efficiency to broaden molecular weight distribution of produced polymers, and/or increasing the temperature at the polymerization reactor outlet (e.g., FIG. 1, at the location of reactor effluent stream 110 exiting polymerization reactor 108). Manipulation of the quenching efficiency may be achieved using one or more (including all) of adjusting the speed of blending of the overhead blender, the quantity of processing aid to alter the viscosity of reactor overflow, and/or altering reactor conditions to impact the viscosity of reactor overflow, such as by increasing the temperature at the reactor outlet.

Such post-polymerization controls generate low molecular weight polymers and prevent both the degradation of said polymers and downstream processing issues.

In one or more aspects of the present disclosure, the amount of quenching agent may be adjusted based on the concentration of catalyst. In one or more aspects, the molar ratio of quenching agent to catalyst is reduced compared to traditional polymerization methods and may be in the range of about 0.4 to about 0.8, such as about 0.4 to about 0.6, or about 0.6 to about 0.8, encompassing any value and subset therebetween.

In one or more aspects of the present disclosure, the overhead blender may be reduced to promote post-polymerization by reducing the overhead blender (see FIG. 1, 108a) speed, or shut as by turning it off completely at one or more stages during polymerization or quenching.

In one or more aspects of the present disclosure, the steam jacket of the overhead piping may be controlled such that the temperature is increased, particularly at the reactor outlet, broadening the MWD thereof. For example, the steam jacket may be adjusted such that the temperature is greater than about −40° C., such as in the range of about −40° C. to about 0° C., or about −20° C. to about 0° C., or about −40° C. to about −20° C., or about −30° C. to about −10° C., encompassing any value and subset therebetween.

The methodologies for controlling the MWD (and MRI) of isobutylene-based elastomers are described further hereinbelow with reference to the Examples.

### Example Embodiments

Nonlimiting example embodiments of the present disclosure include:

Embodiment A: A method comprising: polymerizing a polymerization medium in a reactor, the polymerization medium comprising a monomer, a diluent, and a catalyst system, and the catalyst system comprising a Lewis acid and an initiator, thereby resulting in a reactor overflow; contacting the reactor overflow with a quenching agent; and controlling a quenching of the reactor overflow to obtain a Mooney Relaxation Index (MRI) of greater than about 2.5, thereby resulting in quenched reactor overflow.

Nonlimiting example embodiment A may include one or more of the following elements:
Element 1: Wherein the MRI is in the range of about 2.5 to about 4.5.
Element 2: Wherein the controlling comprises adjusting an amount of quenching agent such that a molar ratio of quenching agent to Lewis acid is in the range of about 0.4 to about 0.8.
Element 3: Wherein the controlling comprises adjusting an amount of quenching agent such that a molar ratio of quenching agent to Lewis acid is in the range of about 0.4 to about 0.6.
Element 4: Wherein the reactor comprises an overhead blender and the controlling comprises reducing a speed or shutting off the overhead blender during one or both of the polymerizing and the quenching.
Element 5: Wherein a reactor outlet comprises a steam jacket and the controlling comprises heating the steam jacket such that a temperature at the reactor outlet is in the range of about −40° C. to about 0° C.
Element 6: Wherein a reactor outlet comprises a steam jacket and the controlling comprises heating the steam jacket such that a temperature at the reactor outlet is in the range of about −30° C. to about −10° C.
Element 7: Wherein the reactor comprises an overhead blender and the controlling comprises (1) reducing a speed or shutting off the overhead blender during one or both of the polymerizing and the quenching and (2) adjusting an amount of quenching agent such that a molar ratio of quenching agent to Lewis acid is in the range of about 0.4 to about 0.8.
Element 8: Wherein the reactor comprises an overhead blender and the controlling comprises (1) reducing a speed or shutting off the overhead blender during one or both of the polymerizing and the quenching, (2) adjusting an amount of quenching agent such that a molar ratio of quenching agent to Lewis acid is in the range of about 0.4 to about 0.8, and wherein a reactor outlet comprises a steam jacket, and wherein the controlling further comprises (3) heating the steam jacket such that a temperature at the reactor outlet is in the range of about −40° C. to about 0° C.
Element 9: Wherein a reactor comprises a steam jacket, and the controlling comprises (1) heating the steam jacket such that a temperature at the reactor outlet is in the range of about −40° C. to about 0° C., and (2) adjusting an amount of quenching agent such that a molar ratio of quenching agent to Lewis acid is in the range of about 0.4 to about 0.8.
Element 10: Wherein the reactor comprises an overhead blender and a reactor outlet comprising a steam jacket, and the controlling comprises (1) shutting off the overhead blender during one or both of the polymerizing and the quenching, and (2) heating the steam jacket such that a temperature at the reactor outlet is in the range of about −40° C. to about 0° C.
Element 11: Wherein the monomer is one or more of an olefin, an alpha-olefin, a di-substituted olefin, an isoolefin, a conjugated diene, a non-conjugated diene, a styrene, a substituted styrene, and a vinyl ether.
Element 12: Wherein the monomer is isobutylene, isoprene, or a combination thereof.
Element 13: Wherein the monomer is present in the polymerization medium in an amount in the range of about 30 wt % to about 40 wt %.
Element 14: Wherein the diluent is one or more of a hydrocarbons, a halogenated hydrocarbon, and a chlorinated hydrocarbons.
Element 15: Wherein the diluent is present in the polymerization medium in an amount in the range of about 60 vol % to about 70 vol %.
Element 16: Wherein the Lewis acid is one or more of aluminum trichloride, aluminum tribromide, ethyl aluminum dichloride, ethyl aluminum sesquichloride, diethyl aluminum chloride, methyl aluminum dichloride, methyl aluminum sesquichloride, and dimethyl aluminum chloride.
Element 17: Wherein the Lewis acid is ethyl aluminum dichloride.
Element 18: Wherein the initiator is one or both of a Brønsted acid, an alkyl halide, and a hydrogen halide.
Element 19: Wherein the quenching agent is at least one alcohol.
Element 20: Wherein the quenching agent is triethylene glycol.
Element 21: Wherein the reactor is a continuous reactor.
Element 22: Further comprising: separating a polymer fraction from the quenched reactor overflow.
Element 23: Wherein the monomer is isobutylene and isoprene, and the polymerizing forms a poly isobutylene-co-isoprene.
Element 24: Wherein the monomer is isobutylene and isoprene, and the polymerizing forms a poly isobutylene-co-isoprene, and further comprising halogenating the poly isobutylene-co-isoprene, thereby forming a halogenated poly isobutylene-co-isoprene.

Each of Elements 1 through 24 may be combined in any combination, without limitation.

To facilitate a better understanding of the embodiments of the present invention, the following examples of preferred or representative embodiments are given. In no way should the following examples be read to limit, or to define, the scope of the invention.

### EXAMPLES

In the following nonlimiting Examples, a Phased approach (Phases 1-5) was taken to adjust post-polymerization reactor conditions using one or more of the factors described hereinabove. In certain instances, previous Phase conditions were retained to a subsequent Phase, as indicated hereinbelow. Data from samples was used to make the adjustments across the Phases and determine MRI (an indicator of the MWD trend), as defined hereinbelow. Gel permeation chromatography (GPC) was used to determine MWD.

All Examples were performed under standard conditions and included a polymerization system comprising isobutylene and isoprene monomers, Lewis acid catalyst of EADC, and a hexane diluent. The quench agent used was TEG.

### Example 1: Phase 1

In this Example, Phase 1 conditions were used in which the ratio of quench agent to catalyst was reduced compared to traditional ratios. The molar ratio of quench agent to catalyst (TEG/EADC) for Phase 1 was greater than 0.6 and less than or equal to about 1.2 (e.g., see Samples P1-4, -7, -8, -11, and -16). The reactor conditions, MRI and Mooney viscosity results are provided in Table 1; samples are approximately 1 hour apart.

TABLE 1

| | | Isobutylene | Isoprene | Feed Blend | Feed Blend |
|---|---|---|---|---|---|
| Sample | TEG/EADC | Conversion | Conversion | Isoprene | Isobutylene |
| No. | (mol ratio) | (%) | (%) | (wt %) | (wt %) |
| P1-1 | 1.20 | 91.11 | 64.77 | 0.82 | 32.27 |
| P1-2 | 1.19 | 90.11 | 63.60 | 0.81 | 32.20 |
| P1-3 | 1.19 | 89.36 | 66.29 | 0.81 | 32.15 |
| P1-4 | 1.22 | 89.09 | 67.48 | 0.81 | 32.06 |
| P1-5 | 1.18 | 88.77 | 69.02 | 0.81 | 32.04 |
| P1-6 | 1.19 | 88.85 | 72.54 | 0.81 | 32.06 |
| P1-7 | 1.23 | 89.00 | 72.28 | 0.81 | 32.05 |
| P1-8 | 1.21 | 88.23 | 69.38 | 0.82 | 32.00 |
| P1-9 | 1.20 | 88.06 | 69.44 | 0.82 | 32.00 |
| P1-10 | 1.19 | 87.97 | 73.26 | 0.82 | 32.00 |
| P1-11 | 1.21 | 86.88 | 68.23 | 0.82 | 32.07 |
| P1-12 | 1.20 | 87.70 | 71.26 | 0.82 | 31.98 |
| P1-13 | 1.19 | 88.79 | 75.02 | 0.82 | 32.05 |
| P1-14 | 1.19 | 89.14 | 73.86 | 0.83 | 32.00 |
| P1-15 | 1.20 | 90.23 | 76.12 | 0.84 | 31.85 |
| P1-16 | 1.21 | 89.30 | 74.70 | 0.84 | 32.00 |

| | Combined | | | | | |
|---|---|---|---|---|---|---|
| | EADC and | | | Polymer | | Production |
| | Diluent | Overhead | Polymer | Mooney | Feed Blend | Rate |
| Sample | Flow | Temperature | MRI | Viscosity | Rate | (T/hr) |
| No. | (Kg/hr) | (° C.) | (MU · Sec) | (MU) | (T/hr) | Mat Bal |
| P1-1 | 992.09 | −49.14 | 2.80 | 41.7 | 11.50 | 6.39 |
| P1-2 | 990.34 | −49.51 | 2.69 | 40.1 | 11.49 | 6.54 |
| P1-3 | 990.15 | −50.18 | 2.44 | 38.1 | 11.49 | 6.54 |
| P1-4 | 996.65 | −50.34 | 2.51 | 37.8 | 11.49 | 6.56 |
| P1-5 | 1044.74 | −50.41 | 2.49 | 37.9 | 11.50 | 6.75 |
| P1-6 | 1041.01 | −50.26 | 2.81 | 34.5 | 11.49 | 6.76 |
| P1-7 | 1018.02 | −50.15 | 2.79 | 39.3 | 11.50 | 6.31 |
| P1-8 | 1017.48 | −50.37 | 2.94 | 37.1 | 11.50 | 6.90 |
| P1-9 | 1017.04 | −50.31 | 2.70 | 38.6 | 11.51 | 6.74 |
| P1-10 | 1016.25 | −49.52 | 2.57 | 38.9 | 11.49 | 6.87 |
| P1-11 | 1016.80 | −50-71 | 2.64 | 40.5 | 11.50 | 6.74 |
| P1-12 | 1022.45 | −50.20 | 2.79 | 40.5 | 11.49 | 6.90 |
| P1-13 | 1044.98 | −51.51 | 2.80 | 39.3 | 11.50 | 6.77 |
| P1-14 | 1049.70 | −49.88 | 2.96 | 37.5 | 11.49 | 6.82 |
| P1-15 | 1083.19 | −51.14 | 2.64 | 37.8 | 11.50 | 6.84 |
| P1-16 | 1083.36 | −52.96 | 2.68 | 37.3 | 11.51 | 6.80 |

The distribution of MRI values for the Phase 1 Samples (having a TEG/EADC of about 1.2) has a median of 2.70 and an average of 2.70 (Phase 1 MRI Samples are plotted in FIG. 2).

### Example 2: Phase 2

In this Example, Phase 2 conditions were used in which the ratio of quench agent to catalyst was further reduced compared to Phase 1 conditions. The molar ratio of quench agent to catalyst (TEG/EADC) for Phase 2 was equal to about 0.6 (e.g., see Samples P2-2, -7, -10, -12). The reactor conditions, MRI, and Mooney viscosity results are provided in Table 2; samples are 2 hours apart.

TABLE 2

| | | Isobutylene | Isoprene | Feed Blend | Feed Blend |
|---|---|---|---|---|---|
| Sample | TEG/EADC | Conversion | Conversion | Isoprene | Isobutylene |
| No. | (mol ratio) | (%) | (%) | (wt %) | (wt %) |
| P2-1 | 0.60 | 89.43 | 71.99 | 0.84 | 32.03 |
| P2-2 | 0.59 | 89.80 | 71.66 | 0.85 | 32.00 |
| P2-3 | 0.60 | 89.68 | 72.36 | 0.86 | 32.00 |
| P2-4 | 0.60 | 89.71 | 70.87 | 0.85 | 32.09 |
| P2-5 | 0.60 | 88.78 | 75.17 | 0.84 | 31.96 |
| P2-6 | 0.60 | 89.90 | 71.24 | 0.84 | 32.04 |
| P2-7 | 0.63 | 88.38 | 71.02 | 0.84 | 31.98 |
| P2-8 | 0.60 | 89.79 | 74.99 | 0.83 | 32.00 |
| P2-9 | 0.60 | 89.75 | 75.45 | 0.83 | 31.98 |
| P2-10 | 0.59 | 90.02 | 76.23 | 0.83 | 32.00 |
| P2-11 | 0.60 | 89.17 | 72.57 | 0.83 | 31.99 |
| P2-12 | 0.61 | 88.40 | 71.70 | 0.83 | 31.95 |

| | Combined | | | | | |
|---|---|---|---|---|---|---|
| | EADC and | | | Polymer | | Production |
| | Diluent | Overhead | Polymer | Mooney | Feed Blend | Rate |
| Sample | Flow | Temperature | MRI | Viscosity | Rate | (T/hr) |
| No. | (Kg/hr) | (° C.) | (MU · Sec) | (MU) | (T/hr) | Mat Bal |
| P2-1 | 1085.41 | −55.46 | 2.76 | 37.8 | 11.51 | 6.68 |
| P2-2 | 1084.18 | −55.63 | 2.67 | 35.1 | 11.49 | 6.92 |
| P2-3 | 1085.09 | −57.08 | 2.64 | 38.0 | 11.49 | 6.75 |
| P2-4 | 1083.95 | −54.89 | 2.71 | 38.0 | 11.50 | 6.82 |
| P2-5 | 1084.57 | −55.19 | 3.03 | 39.6 | 11.49 | 6.95 |
| P2-6 | 1091.64 | −54.43 | 2.91 | 34.8 | 11.50 | 6.95 |
| P2-7 | 1100.19 | −55.91 | 2.79 | 32.7 | 11.50 | 6.95 |
| P2-8 | 1055.11 | −53.84 | 2.72 | 34.7 | 11.50 | 9.79 |
| P2-9 | 1055.63 | −51.77 | 2.72 | 35.2 | 11.50 | 6.97 |
| P2-10 | 1055.34 | −51.72 | 2.77 | 40.0 | 11.51 | 6.79 |
| P2-11 | 1001.06 | −52.12 | 2.71 | 39.9 | 11.50 | 7.01 |
| P2-12 | 1077.05 | −53.76 | 2.75 | 38.7 | 9.51 | 7.26 |

The distribution of MRI values for the Phase 2 Samples (having a TEG/EADC of about 0.6) has a median of 2.74 and an average of 2.77 (Phase 2 MRI Samples are plotted in FIG. 2). Accordingly, using the post-processing methodology of reducing the quench agent to catalyst ratio, a wider MWD was obtained (represented by a higher MRI)—representative of an increase in quantity of low molecular weight polymer fractions compared to Phase 1.

### Example 3: Phase 3

In this Example, Phase 3 conditions were used in which the reduced ratio of quench agent to catalyst of Phase 2 (TEG/EADC=−0.6) was combined with turning off the overhead blender of the reactor, thereby impacting the mixing of the catalyst and quench agent. The reactor conditions, MRI, and Mooney viscosity results are provided in Table 3; samples are approximately 2 hours apart.

TABLE 3

| | | Isobutylene | Isoprene | Feed Blend | Feed Blend |
|---|---|---|---|---|---|
| Sample | TEG/EADC | Conversion | Conversion | Isoprene | Isobutylene |
| No. | (mol ratio) | (%) | (%) | (wt %) | (wt %) |
| P3-1 | 0.62 | 88.71 | 74.70 | 0.83 | 31.94 |
| P3-2 | 0.60 | 90.70 | 71.07 | 0.84 | 31.98 |
| P3-3 | 0.61 | 90.57 | 75.09 | 0.85 | 32.00 |
| P3-4 | 0.60 | 90.46 | 77.54 | 0.84 | 32.03 |
| P3-5 | 0.60 | 91.02 | 75.55 | 0.84 | 31.96 |
| P3-6 | 0.59 | 91.96 | 76.95 | 0.84 | 32.06 |
| P3-7 | 0.60 | 91.75 | 75.90 | 0.84 | 32.06 |
| P3-8 | 0.60 | 91.43 | 78.22 | 0.87 | 31.95 |
| P3-9 | 0.61 | 88.51 | 75.80 | 0.87 | 31.98 |
| P3-10 | 0.60 | 89.17 | 71.81 | 0.84 | 32.04 |
| P3-11 | 0.60 | 90.15 | 75.44 | 0.84 | 32.01 |
| P3-12 | 0.60 | 90.99 | 75.02 | 0.85 | 32.01 |
| P3-13 | 0.60 | 91.68 | 78.00 | 0.86 | 31.97 |
| P3-14 | 0.61 | 93.54 | 80.28 | 0.87 | 32.00 |
| P3-15 | 0.61 | 91.54 | 75.16 | 0.86 | 32.00 |

| | Combined | | | Polymer | | Production |
|---|---|---|---|---|---|---|
| | EADC and | Overhead | Polymer | Mooney | Feed Blend | Rate |
| Sample | Diluent Flow | Temperature | MRI | Viscosity | Rate | (T/hr) |
| No. | (Kg/hr) | (° C.) | (MU · Sec) | (MU) | (T/hr) | Mat Bal |
| P3-1 | 1027.58 | −58.59 | 3.07 | 40.9 | 11.50 | 7.12 |
| P3-2 | 1028.95 | −56.18 | 3.02 | 39.3 | 11.50 | 6.99 |
| P3-3 | 1028.68 | −59.04 | 2.92 | 39.0 | 11.50 | 7.06 |
| P3-4 | 1028.20 | −55.90 | 2.99 | 33.6 | 11.51 | 7.04 |
| P3-5 | 1028.05 | −59.43 | 3.13 | 34.6 | 11.51 | 6.92 |
| P3-6 | 1028.95 | −54.43 | 2.93 | 31.0 | 11.50 | 6.93 |
| P3-7 | 1030.09 | −56.09 | 2.83 | 39.9 | 11.50 | 6.83 |
| P3-8 | 1027.24 | −57.36 | 2.76 | 38.7 | 11.51 | 6.87 |
| P3-9 | 1028.99 | −55.47 | 3.19 | 42.8 | 11.50 | 6.98 |
| P3-10 | 1028.76 | −51.85 | 3.30 | 35.5 | 11.50 | 6.90 |
| P3-11 | 1029.14 | −55.35 | 2.91 | 37.7 | 11.50 | 6.80 |
| P3-12 | 1057.29 | −56.02 | 2.86 | 37.7 | 11.50 | 6.89 |
| P3-13 | 1055.90 | −60.37 | 2.91 | 35.0 | 11.50 | 6.92 |
| P3-14 | 1057.00 | −64.08 | 3.02 | 36.6 | 11.50 | 6.85 |
| P3-15 | 1056.81 | −53.89 | 2.73 | 36.6 | 11.50 | 7.01 |

The distribution of MRI values for the Phase 3 Samples (having a TEG/EADC of about 0.6 and with turning off the overhead blender) has a median of 2.93 and an average of 2.97 (Phase 3 MRI Samples are plotted in FIG. 2). Accordingly, using the post-processing (methodology of reducing the quench agent to catalyst ratio in addition to turning off the overhead blender of the reactor, a wider MWD was obtained (represented by a higher MRI)—representative of an increase in quantity of low molecular weight polymer fractions compared to both Phase 1 and Phase 2 conditions.

### Example 4: Phase 4

In this Example, Phase 4 conditions were used having a further reduced ratio of quench agent to catalyst compared to Phase 3 combined with turning off the overhead blender of the reactor, thereby impacting the mixing of the catalyst and quench agent. The molar ratio of quench agent to catalyst (TEG/EADC) for Phase 4 was about 0.5 (e.g., see Samples P4-1, -7, -9, -10, -11). The reactor conditions, MRI, and Mooney viscosity results are provided in Table 4; samples are approximately 2 hours apart.

TABLE 4

| | | Isobutylene | Isoprene | Feed Blend | Feed Blend |
|---|---|---|---|---|---|
| Sample | TEG/EADC | Conversion | Conversion | Isoprene | Isobutylene |
| No. | (mol ratio) | (%) | (%) | (wt %) | (wt %) |
| P4-1 | 0.51 | 89.23 | 73.76 | 0.85 | 32.50 |
| P4-2 | 0.50 | 91.66 | 74.90 | 0.86 | 32.48 |
| P4-3 | 0.50 | 92.47 | 78.82 | 0.86 | 32.49 |
| P4-4 | 0.50 | 93.21 | 80.92 | 0.86 | 32.49 |
| P4-5 | 0.50 | 93.57 | 81.83 | 0.85 | 32.56 |
| P4-6 | 0.50 | 94.32 | 79.76 | 0.85 | 32.44 |
| P4-7 | 0.51 | 93.54 | 80.05 | 0.87 | 32.50 |
| P4-8 | 0.50 | 92.46 | 81.28 | 0..85 | 32.43 |
| P4-9 | 0.51 | 92.44 | 86.86 | 0.85 | 32.50 |
| P4-10 | 0.49 | 92.11 | 78.74 | 0.86 | 32.56 |
| P4-11 | 0.51 | 93.21 | 79.25 | 0.87 | 32.49 |
| P4-12 | 0.50 | 93.15 | 79.92 | 0.87 | 32.48 |
| P4-13 | 0.50 | 94.42 | 82.37 | 0.86 | 32.49 |
| P4-14 | 0.50 | 93.16 | 78.44 | 0.86 | 32.56 |

| | Combined | | | | | |
|---|---|---|---|---|---|---|
| | EADC and | | | Polymer | | Production |
| | Diluent | Overhead | Polymer | Mooney | Feed Blend | Rate |
| Sample | Flow | Temperature | MRI | Viscosity | Rate | (T/hr) |
| No. | (Kg/hr) | (° C.) | (MU · Sec) | (MU) | (T/hr) | Mat Bal |
| P4-1 | 1072.97 | −51.33 | 3.44 | 39.7 | 11.50 | 7.10 |
| P4-2 | 1075.91 | −54.21 | 3.14 | 38.5 | 11.50 | 7.17 |
| P4-3 | 1076.79 | −52.03 | 3.17 | 37.4 | 11.50 | 7.21 |
| P4-4 | 1077.51 | −52.69 | 3.60 | 35.1 | 11.49 | 7.17 |
| P4-5 | 1076.06 | −52.34 | 3.39 | 36.1 | 11.50 | 7.00 |
| P4-6 | 1076.50 | −50.00 | 3.05 | 36.8 | 11.50 | 6.91 |
| P4-7 | 1077.91 | −44.30 | 3.18 | 34.5 | 11.49 | 7.43 |
| P4-8 | 1075.46 | −49.17 | 3.40 | 38.2 | 11.50 | 7.15 |
| P4-9 | 1075.38 | −50.66 | 3.15 | 37.8 | 11.50 | 7.18 |
| P4-10 | 1086.39 | −51.60 | 3.19 | 37.5 | 11.50 | 6.98 |
| P4-11 | 1132.28 | −51.21 | 2.90 | 35.8 | 11.50 | 7.07 |
| P4-12 | 1131.50 | −50.68 | 3.00 | 36.2 | 11.50 | 7.16 |
| P4-13 | 1131.62 | −51.07 | 3.03 | 35.9 | 11.50 | 7.18 |
| P4-14 | 1131.92 | −53.00 | 3.17 | 35.6 | 11.49 | 7.05 |

The distribution of MRI values for the Phase 4 Samples (having a TEG/EADC of about 0.5 and with turning off the overhead blender) has a median of 3.17 and an average of 3.20 (Phase 4 MRI Samples are plotted in FIG. 2). Accordingly, using the post-processing methodology of reducing the quench agent to catalyst ratio to about 0.5 in addition to turning off the overhead blender of the reactor, a wider MWD was obtained (represented by a higher MRI)—representative of an increase in quantity of low molecular weight polymer fractions compared to each of Phases 1-3 conditions.

### Example 5: Phase 5

In this Example, Phase 5 conditions were used in which all of Phase 4 conditions were combined with the temperature of overhead stream of the reactor increased (e.g., via steam) to promote post-polymerization reaction. Note that the lowest temperature in Phase 5 is about −30° C., as shown below. The reactor conditions, MRI, and Mooney viscosity results are provided in Table 5; samples are approximately 2 hours apart.

TABLE 5

| | | Isobutylene | Isoprene | Feed Blend | Feed Blend |
|---|---|---|---|---|---|
| Sample | TEG/EADC | Conversion | Conversion | Isoprene | Isobutylene |
| No. | (mol ratio) | (%) | (%) | (wt %) | (wt %) |
| P5-1 | 0.50 | 92.58 | 81.55 | 0.85 | 32.50 |
| P5-2 | 0.50 | 93.18 | 83.65 | 0.85 | 32.53 |
| P5-3 | 0.50 | 93.42 | 83.64 | 0.85 | 32.49 |
| P5-4 | 0.49 | 94.11 | 83.30 | 0.86 | 32.48 |
| P5-5 | 0.50 | 93.21 | 81.66 | 0.86 | 32.51 |
| P5-6 | 0.61 | 92.93 | 82.78 | 0.81 | 32.52 |
| P5-7 | 0.41 | 93.57 | 81.80 | 0.85 | 32.49 |
| P5-8 | 0.52 | 93.39 | 82.91 | 0.86 | 32.51 |
| P5-9 | 0.52 | 93.03 | 84.00 | 0.87 | 32.54 |
| P5-10 | 0.49 | 92.94 | 83.31 | 0.87 | 32.51 |
| P5-11 | 0.49 | 92.60 | 82.17 | 0.87 | 32.51 |
| P5-12 | 0.50 | 92.86 | 81.42 | 0.86 | 32.52 |
| P5-13 | 0.48 | 93.81 | 82.08 | 0.87 | 32.49 |
| P5-14 | 0.49 | 92.61 | 81.55 | 0.88 | 32.50 |

| | Combined | | | | | |
|---|---|---|---|---|---|---|
| | EADC and | | | Polymer | | Production |
| | Diluent | Overhead | Polymer | Mooney | Feed Blend | Rate |
| Sample | Flow | Temperature | MRI | Viscosity | Rate | (T/hr) |
| No. | (Kg/hr) | (° C.) | (MU · Sec) | (MU) | (T/hr) | Mat Bal |
| P5-1 | 1585.13 | −18.10 | 3.44 | 38.4 | 16.00 | 14.97 |
| P5-2 | 1587.88 | −19.07 | 3.50 | 38.7 | 15.99 | 14.82 |
| P5-3 | 1622.09 | −21.95 | 3.03 | 37.2 | 16.00 | 14.79 |
| P5-4 | 1619.51 | −23.61 | 3.23 | 36.8 | 16.00 | 14.85 |
| P5-5 | 1620.38 | −18.83 | 3.32 | 36.6 | 16.00 | 14.98 |
| P5-6 | 1611.09 | −19.86 | 3.12 | 35.7 | 16.00 | 14.04 |
| P5-7 | 1620.24 | −20.82 | 3.09 | 35.8 | 16.01 | 15.16 |
| P5-8 | 1619.62 | −29.12 | 3.46 | 33.9 | 16.00 | 14.96 |
| P5-9 | 1620.59 | −24.74 | 3.25 | 36.7 | 16.00 | 14.82 |
| P5-10 | 1620.34 | −23.40 | 3.09 | 36.9 | 16.00 | 14.89 |
| P5-11 | 1621.33 | −18.90 | 3.43 | 36.0 | 16.02 | 14.75 |
| P5-12 | 1618.12 | −17.29 | 3.12 | 35.9 | 16.00 | 14.80 |
| P5-13 | 1618.60 | −14.67 | 3.03 | 38.3 | 16.00 | 14.72 |
| P5-14 | 1621.35 | −11.91 | 3.29 | 36.1 | 16.00 | 14.89 |

The distribution of MRI values for the Phase 5 Samples (having a TEG/EADC of about 0.5, turning off the overhead blender, and increasing the temperature of the overhead stream) has a median of 3.24 and an average of 3.24 (Phase 5 MRI Samples are plotted in FIG. 2). Accordingly, using the post-processing methodology of reducing the quench agent to catalyst ratio to about 0.5 in addition to both turning off the overhead blender of the reactor and increasing temperature at the reactor outlet, a wider MWD was obtained (represented by a higher MRI)—representative of an increase in quantity of low molecular weight polymer fractions compared to each of Phases 1-4 conditions.

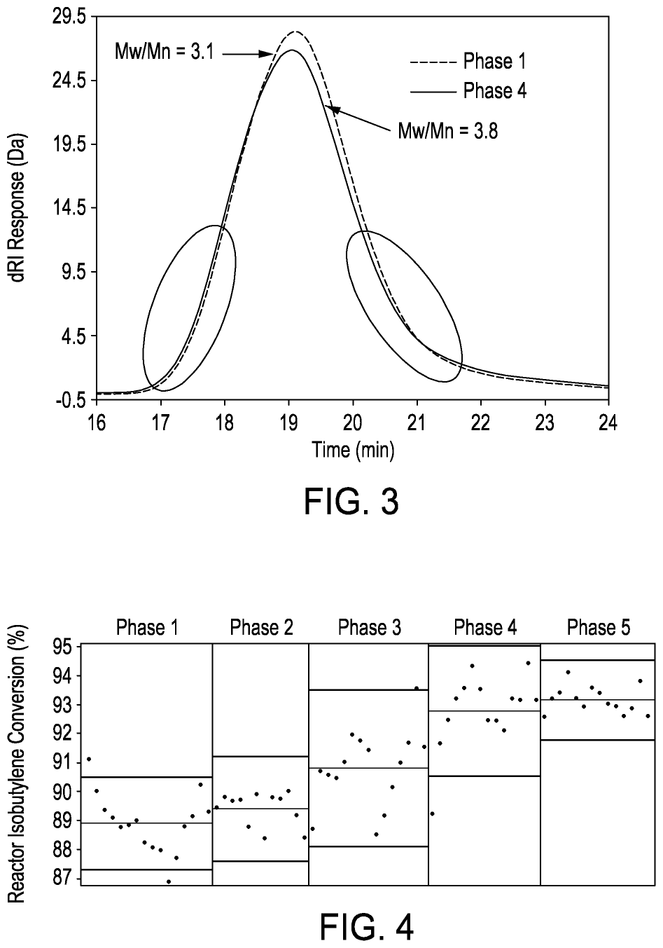

With reference to Examples 1-5, FIG. 2 is a chart showing the MRI values for each of Phase 1-5 described above. The average MRI between the Phase conditions ranged from 2.7 to 3.24. It is again noted that MRI is indicative of MWD but the absolute values between MRI and MWD are not equal; an increasing trend in MRI indicates an increasing trend in MWD. Indeed, referring now to FIG. 3, which is a gel permeation chromatography chart showing the MWD for the results of Example 1 (Phase 1) herein and Example 4 (Phase 4) herein. As shown, the MWD for Phase 1 is 3.1, wherein the MWD for Phase 4 has significantly shifted to 3.8. Accordingly, both MRI and MWD significantly increase by employing one or more of the post-polymerization methodologies of the present disclosure in the resultant butyl rubber, believed (without being bound by theory) to represent an increase in lower molecular weight polymers.

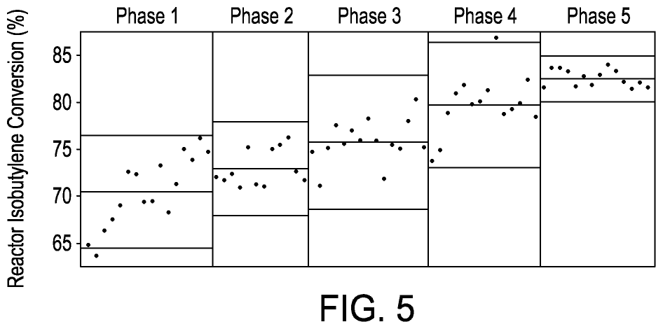

Moreover, Examples 1-5 demonstrate an overall increase in the conversion of raw materials for similar reactant resident times. FIG. 4 is a chart displaying isobutylene conversion values for experimental phase conditions, according to one or more embodiments of the present disclosure. FIG. 5 is a chart displaying isobutylene conversion values for experimental phase conditions, according to one or more embodiments of the present disclosure.

### Example 6

In this example, a commercially available butyl rubber of a copolymer of isobutylene and isoprene was prepared according to confidential specifications (Control Samples C1-C12) and thereafter, prepared according to Phase 5 conditions (maintaining all other conditions without alteration) (Experimental Samples E1-E12). The MRI and Mooney Viscosity results are shown in Table 6 below.

TABLE 6

| | Polymer MRI | Polymer Mooney Viscosity |
|---|---|---|
| Sample No. | (MU · Sec) | (MU) |
| C1 | 3.20 | 50.7 |
| C2 | 3.17 | 50.9 |
| C3 | 3.22 | 50.3 |
| C4 | 3.32 | 50.1 |
| C5 | 3.22 | 49.6 |
| C6 | 3.26 | 49.7 |
| C7 | 3.21 | 49.6 |
| C8 | 3.30 | 49.5 |
| C9 | 3.18 | 49.8 |
| C10 | 3.29 | 49.6 |
| C11 | 3.25 | 49.3 |
| C12 | 3.10 | 50.0 |
| E1 | 3.98 | 53.4 |
| E2 | 4.31 | 51.8 |
| E3 | 4.01 | 51.0 |
| E4 | 3.95 | 54.0 |
| E5 | 4.15 | 54.7 |
| E6 | 4.16 | 57.1 |
| E7 | 4.16 | 57.6 |
| E8 | 4.06 | 55.5 |
| E9 | 3.98 | 52.3 |
| E10 | 3.9 | 50.3 |
| E11 | 3.81 | 49.1 |
| E12 | 3.75 | 50.8 |

The distribution of MRI values for the Control Samples has a median of 3.22 and an average of 3.23, whereas the distribution of MRI values for the Experimental Samples (treated per Phase 5 described herein) has a median 4.00 and an average of 4.02. This Example, again, shows that using the post-processing methodologies of the present disclosure results in a wider MWD (represented by a higher MRI)—representative of an increase in quantity of low molecular weight polymer fractions.

### Example 7

In this example, a commercially available halogenated (functionalized) butyl rubber of a copolymer of isobutylene and isoprene was prepared according to confidential specifications (Control Samples C13-C24) and thereafter, prepared according to Phase 5 conditions (maintaining all other conditions without alteration) (Experimental Samples E13-E24). The MRI and Mooney Viscosity results are shown in Table 7 below.

TABLE 7

| | Polymer MRI | Polymer Mooney Viscosity |
|---|---|---|
| Sample No. | (MU · Sec) | (MU) |
| C13 | 3.3 | 37.8 |
| C14 | 3.3 | 36.2 |
| C15 | 3.3 | 34.1 |
| C16 | 3.7 | 32.9 |
| C17 | 3.3 | 33.8 |
| C18 | 3.3 | 33.4 |
| C19 | 3.2 | 33.2 |
| C20 | 3.3 | 33.2 |
| C21 | 3.5 | 33.3 |
| C22 | 3.7 | 34.6 |
| C23 | 3.2 | 32.5 |
| C24 | 3.4 | 32.9 |
| E13 | 4.4 | 33.4 |
| E14 | 4.2 | 33.7 |
| E15 | 3.9 | 33.3 |
| E16 | 4.1 | 33.4 |
| E17 | 4.1 | 33.1 |
| E18 | 4.2 | 32.9 |
| E19 | 3.9 | 33.4 |
| E20 | 3.9 | 34.1 |
| E21 | 4.0 | 32.9 |
| E22 | 3.9 | 31.7 |
| E23 | 4.4 | 30.4 |
| E24 | 4.1 | 30.4 |

The distribution of MRI values for the Control Samples has a median of 3.3 and an average of 3.4, whereas the distribution of MRI values for the Experimental Samples (treated per Phase 5 described herein) has a median 4.1 and an average of 4.1. This Example, again, shows that using the post-processing methodologies of the present disclosure results in a wider MWD (represented by a higher MRI)—representative of an increase in quantity of low molecular weight polymer fractions, including when halogenated butyl rubber is processed.

Therefore, the present disclosure demonstrates that post-polymerization controls and modifications of a polymerization system according to one or more methodologies of the present disclosure can be used to broaden the molecular weight distribution of the resultant polymers.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps. Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
polymerizing a polymerization medium in a reactor, the polymerization medium comprising a monomer, a diluent, and a catalyst system, and the catalyst system comprising a Lewis acid and an initiator, thereby resulting in a reactor overflow;
contacting the reactor overflow with a quenching agent; and
controlling a quenching of the reactor overflow to obtain a Mooney Relaxation Index (MRI) of greater than about 2.5, thereby resulting in quenched reactor overflow.

2. The method of claim 1, wherein the MRI is in the range of about 2.5 to about 4.5.

3. The method of claim 1, wherein the controlling comprises adjusting an amount of quenching agent such that a molar ratio of quenching agent to Lewis acid is in the range of about 0.4 to about 0.8.

4. The method of claim 3, wherein the molar ratio of quenching agent to Lewis acid is in the range of about 0.4 to about 0.6.

5. The method of claim 1, wherein the reactor comprises an overhead blender and the controlling comprises reducing a speed or shutting off the overhead blender during one or both of the polymerizing and the quenching.

6. The method of claim 1, wherein a reactor outlet comprises a steam jacket and the controlling comprises heating the steam jacket such that a temperature at the reactor outlet is in the range of about −40° C. to about 0° C.

7. The method of claim 5, wherein the temperature at the reactor outlet is in the range of about −30° C. to about −10° C.

8. The method of claim 1, wherein the reactor comprises an overhead blender and the controlling comprises (1) reducing a speed or shutting off the overhead blender during one or both of the polymerizing and the quenching and (2) adjusting an amount of quenching agent such that a molar ratio of quenching agent to Lewis acid is in the range of about 0.4 to about 0.8.

9. The method of claim 8, wherein a reactor outlet comprises a steam jacket, and wherein the controlling further comprises (3) heating the steam jacket such that a temperature at the reactor outlet is in the range of about −40° C. to about 0° C.

10. The method of claim 1, wherein a reactor outlet comprises a steam jacket, and the controlling comprises (1) heating the steam jacket such that a temperature at the reactor outlet is in the range of about −40° C. to about 0° C., and (2) adjusting an amount of quenching agent such that a molar ratio of quenching agent to Lewis acid is in the range of about 0.4 to about 0.8.

11. The method of claim 1, wherein the reactor comprises an overhead blender and a reactor outlet comprising a steam jacket, and the controlling comprises (1) reducing a speed or shutting off the overhead blender during one or both of the polymerizing and the quenching, and (2) heating the steam jacket such that a temperature at the reactor outlet is in the range of about −40° C. to about 0° C.

12. The method of claim 1, wherein the monomer is one or more of an olefin, an alpha-olefin, a di-substituted olefin, an isoolefin, a conjugated diene, a non-conjugated diene, a styrene, a substituted styrene, and a vinyl ether.

13. The method of claim 1, wherein the monomer is isobutylene, isoprene, or a combination thereof.

14. The method of claim 1, wherein the monomer is present in the polymerization medium in an amount in the range of about 30 wt % to about 40 wt %.

15. The method of claim 1, wherein the diluent is one or more of a hydrocarbons, a halogenated hydrocarbon, and a chlorinated hydrocarbons.

16. The method of claim 1, wherein the diluent is present in the polymerization medium in an amount in the range of about 60 vol % to about 70 vol %.

17. The method of claim 1, wherein the Lewis acid is one or more of aluminum trichloride, aluminum tribromide, ethyl aluminum dichloride, ethyl aluminum sesquichloride, diethyl aluminum chloride, methyl aluminum dichloride, methyl aluminum sesquichloride, and dimethyl aluminum chloride.

18. The method of claim 1, wherein the Lewis acid is ethyl aluminum dichloride.

19. The method of claim 1, wherein the initiator is one or both of a Brønsted acid, an alkyl halide, and a hydrogen halide.

20. The method of claim 1, wherein the quenching agent is at least one alcohol.

21. The method of claim 1, wherein the quenching agent is triethylene glycol.

22. The method of claim 1, wherein the reactor is a continuous reactor.

23. The method of claim 1, further comprising:
separating a polymer fraction from the quenched reactor overflow.

24. The method of claim 1, wherein the monomer is isobutylene and isoprene, and the polymerizing forms a poly isobutylene-co-isoprene.

25. The method of claim 24, further comprising halogenating the poly isobutylene-co-isoprene, thereby forming a halogenated poly isobutylene-co-isoprene.
